(19) United States
(12) Patent Application Publication
(10) Pub. No.: US 2017/0316386 A1
(43) Pub. Date: Nov. 2, 2017

(54) CONTEXTUALLY-AWARE SCHEDULING EXCEPTIONS

(71) Applicant: Microsoft Technology Licensing, LLC, Redmond, WA (US)

(72) Inventors: Neel Joshi, Kirkland, WA (US); William Hart Holmes, Seattle, WA (US); Paul David Tischhauser, Redmond, WA (US); Chandresh K. Jain, Sammamish, WA (US); Mohit Mehtani, Redmond, WA (US); Anant Trivedi, Seattle, WA (US); Eva Britta Karolina Burlin, Newcastle, WA (US); Dana Anne Lee, Seattle, WA (US); Joan Ching Li, Seattle, WA (US)

(21) Appl. No.: 15/142,818

(22) Filed: Apr. 29, 2016

(51) Int. Cl. G06Q 10/10

(52) U.S. Cl. CPC G06Q 10/1095; G06Q 10/1091

(57) ABSTRACT

Techniques described herein provide mechanisms for generating contextually-aware scheduling exceptions. In some configurations, when a scheduling conflict is detected, the techniques disclosed herein can utilize contextual data from a number of resources to determine if a scheduling exception can be made. The contextual data can include preferences, such as preferences of a service provider or a customer, that define criteria and/or goals. The techniques disclosed herein prioritize customers based on the contextual data and provide different scheduling options for customers and other entities based on a priority associated with individual customers. When there is a conflict between two or more calendar events, a scheduling exception can be made for some customers and a scheduling conflict can be made for other customers depending on one or more priorities associated with the customers.

### BACKGROUND

When scheduling appointments, computer users can be presented with a number of challenging tasks. For instance, when customers want to schedule appointments with a service provider, a customer's view of a provider's calendar may be limited. Although some existing systems can display timeslots indicating when a provider is available, the displayed scheduling information does not usually show any relevant insights to help the customer find the most suitable time for all involved parties. For example, when open timeslots are limited, it may be difficult for a customer to coordinate the open timeslots of the provider's calendar with their own calendar.

In addition to the above-described drawbacks, some existing calendaring programs offer a limited number of features to users that publish their calendars via a public interface, e.g., a Website or an interface to mobile applications. For example, when a business, such as a doctor's office or auto repair shop, publishes a calendar to customers, it is difficult for the business to influence how customers select timeslots. Given these issues, and others, some existing calendaring systems do not enable users to optimize their calendars to benefit all involved parties.

It is with respect to these and other considerations that the disclosure made herein is presented.

### SUMMARY

Techniques described herein provide mechanisms for generating contextually-aware scheduling exceptions. In some configurations, when a scheduling conflict is detected, the techniques disclosed herein can utilize contextual data from a number of resources to determine if a scheduling exception can be made. The contextual data can include preferences, such as preferences of a service provider or a customer, that define criteria and/or goals. The techniques disclosed herein enable providers to prioritize customers and cause the execution of different actions based on a priority of one or more customers that help service providers achieve one or more goals. In addition, the techniques disclosed herein enable customers to identify one or more providers that helps them achieve one or more goals.

In some configurations, one or more devices can make scheduling exceptions in one or more circumstances. For example, if two customers schedule appointments that conflict with one another, the techniques disclosed herein enable the two appointments to exist if the two conflicting appointments meet one or more conditions. The conditions can be based on data defining a severity of a conflict, which may be based on a probability of a commute, locations of the appointments, and other factors. The conditions can also be based on data defining a priority of a customer or a priority of a service provider.

In one illustrative example, a computing device can generate priority data indicating a priority for individual customers of a plurality of customers based, at least in part, on an analysis of contextual data. The contextual data can include, but is not limited to, map data, traffic data, location data, weather data, map data, scheduling data, workload data, work history data, payment data, and specialty data. In some configurations, the contextual data includes provider preferences defining criteria and/or goals. For instance, a provider may have a goal of developing customers in a particular segment, e.g., high-volume customers, high-profile customers, and/or customers having a threshold credit score. The use of multiple goals, e.g., a desire to acquire customers that are both high-volume and high profile, enables service providers to analyze the contextual data to identify and accommodate customers having a “lifetime value” that meet or exceed a threshold. In addition, the techniques can use the contextual data to take other actions, e.g., automatically select customers for termination, automatically select customers for special pricing, etc.

In addition to generating priority data, the computing device can receive scheduling data defining a first calendar event associated with a first customer and a second calendar event associated with a second customer. The scheduling data can define a start time and an end time for each appointment. The scheduling data can also include location data if an appointment is associated with a geographic location, global coordinates, an address, a room number and other information identifying a location.

The computing device can process the scheduling data to determine if a scheduling conflict exists between the first calendar event and the second calendar event. A conflict can be determined using a number of different factors. For instance, if the first calendar event and the second calendar event overlap, a conflict may be detected. A degree of overlap of two or more appointments can be used to generate data defining a severity of a conflict. In other examples, if the first calendar event and the second calendar event include location data, contextual data, such as map data, weather data, and traffic data, can be utilized to determine a probability of a commute between the two calendar events. The probability of a commute can be processed alone or with other data, such as the degree of overlap, to generate data defining a severity of a conflict.

The priority of one or more users, such as a priority of a service provider or a priority of a customer, can be used to influence the data defining a severity of a conflict. In such configurations, the data defining a severity of a conflict can have individual severity levels that are each associated with individual users or individual calendar events. For example, the data defining a severity of a conflict may comprise a first severity level associated with the first customer and a second severity level associated with a second customer. This type of data structure may be utilized to take one type of action, such as send a confirmation of a calendar event, for the first customer, and another type of action, such as a modification of a calendar event, for the second customer.

For illustrative purposes, consider a scenario where priority data indicates that the first customer is a higher priority than the second customer. If the first customer attempts to schedule an appointment that conflicts with an appointment associated with the second customer, a first severity level of the conflict may be reduced for the first customer since the first customer has a higher priority than the second customer. In such a scenario, the first customer may receive data indicating an exception to the conflict, e.g., receive confirmation of the appointment. However, a second severity level indicating the severity of the conflict for the second customer may be increased since the second customer has a lower priority than the first customer. In such a scenario, the second customer can receive an indication or notification of the conflict. In some configurations, the second customer may receive a cancellation notice or a modified calendar event recommending a new time.

In some configurations, the techniques disclosed herein can generate data indicating the scheduling conflict if the severity of a conflict meets or exceeds a threshold level. The data indicating the scheduling conflict can be in the form of a notification or message. In some cases, the data indicating the scheduling conflict can be a new calendar event recommending an alternative time. In some configurations, the data indicating the scheduling conflict can be a “decline” notification that is sent in response to a meeting request. The data indicating the scheduling conflict can be sent to attendees associated with at least one calendar event involved in the conflict. In some configurations, the data indicating the scheduling conflict is sent to the customer having the lowest priority of the customers involved in the conflict.

The computing device can generate data indicating a scheduling exception if the severity of a conflict does not meet or does not exceed a threshold level. The data indicating the scheduling exception can be in the form of a notification or message indicating one or more parameters related to the conflict. For instance, a message may indicate the presence of an overlapping meeting. A message or notification can also indicate that a meeting may be abridged in some manner. In some configurations, if the severity of a conflict does not meet or does not exceed a threshold level, the system can allow two conflicting calendar events to coexist. Although these examples utilize one or more threshold levels, it can be appreciated that techniques disclosed herein can utilize any suitable technology for analyzing data against any suitable criteria.

In another illustrative example, the techniques disclosed herein can prioritize customers and grant different levels of access to calendar data to individual customers based, at least in part, on an associated priority level. As will be described in more detail below, granting different levels of access based on a customer priority level enables high-priority customers to view, edit and reserve timeslots that may not be available to other customers.

The generation of different types of actions for customers having different priority levels, enables service providers or any other entity publishing a calendar can have influence on the type of customers that can schedule time on the published calendar. In addition, service providers or any other entity publishing a calendar can utilize the techniques disclosed herein to control the type of scheduling data that is published to customers and other computer users based, at least in part, on the contextual data and other data, such as the priority data. These examples are provided for illustrative purposes is not to be construed as limiting.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicates similar or identical items.

FIG. 1 is a block diagram showing an illustrative system for generating contextually-aware scheduling exceptions;

FIGS. 2A-2B include block diagrams showing an illustrative example of a scheduling conflict and data defining a scheduling exception;

FIGS. 3A-3B include block diagrams showing an illustrative example of prioritized customers having different levels of access to scheduling data of a provider;

FIG. 4 is a flow diagram showing a routine illustrating aspects of a mechanism disclosed herein for generating contextually-aware scheduling exceptions.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

FIG. 7 is a computer architecture diagram illustrating a computing device architecture for a computing device capable of implementing aspects of the techniques and technologies presented herein.

### DETAILED DESCRIPTION

The following Detailed Description describes technologies for generating data defining contextually-aware scheduling exceptions. In some configurations, when a scheduling conflict is detected, the techniques disclosed herein can utilize contextual data from a number of resources to determine if a scheduling exception can be made. The contextual data can include preferences, such as preferences of a service provider or a customer, that define criteria and/or goals. The techniques disclosed herein enable providers to prioritize customers and cause the execution of different actions based on a priority of one or more customers that help service providers achieve one or more goals. In addition, the techniques disclosed herein enable customers to identify one or more providers that helps them achieve one or more goals.

In some configurations, one or more devices can make scheduling exceptions in one or more circumstances. For example, if two customers schedule appointments that conflict with one another, the techniques disclosed herein enable the two appointments to exist if the two conflicting appointments meet one or more conditions. The conditions can be based on data defining a severity of a conflict, which may be based on a probability of a commute, locations of the appointments, and other factors. The conditions can also be based on data defining a priority of a customer or a priority of a service provider.

In one illustrative example, a computing device can generate priority data indicating a priority for individual customers of a plurality of customers based, at least in part, on an analysis of contextual data. The contextual data can include, but is not limited to, map data, traffic data, location data, weather data, map data, scheduling data, workload data, work history data, payment data, and specialty data. In some configurations, the contextual data includes provider preferences defining criteria and/or goals. For instance, a provider may have a goal of developing customers in a particular segment, e.g., high-volume customers, high-profile customers, and/or customers having a threshold credit score. The use of multiple goals, e.g., a desire to acquire customers that are both high-volume and high profile, enables service providers to analyze the contextual data to identify and accommodate customers having a “lifetime value” that meet or exceed a threshold. In addition, the techniques can use the contextual data to take other actions, e.g., automatically select customers for termination, automatically select customers for special pricing, etc.

In addition to generating priority data, the computing device can receive scheduling data defining a first calendar event associated with a first customer and a second calendar event associated with a second customer. The scheduling data can define a start time and an end time for each appointment. The scheduling data can also include location data if an appointment is associated with a geographic location, global coordinates, an address, a room number and other information identifying a location.

The computing device can process the scheduling data to determine if a scheduling conflict exists between the first calendar event and the second calendar event. A conflict can be determined using a number of different factors. For instance, if the first calendar event and the second calendar event overlap, a conflict may be detected. A degree of overlap of two or more appointments can be used to generate data defining a severity of a conflict. In other examples, if the first calendar event and the second calendar event include location data, contextual data, such as map data, weather data, and traffic data, can be utilized to determine a probability of a commute between the two calendar events. The probability of a commute can be processed alone or with other data, such as the degree of overlap, to generate data defining a severity of a conflict.

The priority of one or more users, such as a priority of a service provider or a priority of a customer, can be used to influence the data defining a severity of a conflict. In such configurations, the data defining a severity of a conflict can have individual severity levels that are each associated with individual users or individual calendar events. For example, the data defining a severity of a conflict may comprise a first severity level associated with the first customer and a second severity level associated with a second customer. This type of data structure may be utilized to take one type of action, such as send a confirmation of a calendar event, for the first customer, and another type of action, such as a modification of a calendar event, for the second customer.

For illustrative purposes, consider a scenario where priority data indicates that the first customer is a higher priority than the second customer. If the first customer attempts to schedule an appointment that conflicts with an appointment associated with the second customer, a first severity level of the conflict may be reduced for the first customer since the first customer has a higher priority than the second customer. In such a scenario, the first customer may receive data indicating an exception to the conflict, e.g., receive confirmation of the appointment. However, a second severity level indicating the severity of the conflict for the second customer may be increased since the second customer has a lower priority than the first customer. In such a scenario, the second customer can receive an indication or notification of the conflict. In some configurations, the second customer may receive a cancellation notice or a modified calendar event recommending a new time.

In some configurations, the techniques disclosed herein can generate data indicating the scheduling conflict if the severity of a conflict meets or exceeds a threshold level. The data indicating the scheduling conflict can be in the form of a notification or message. In some cases, the data indicating the scheduling conflict can be a new calendar event recommending an alternative time. In some configurations, the data indicating the scheduling conflict can be a “decline” notification that is sent in response to a meeting request. The data indicating the scheduling conflict can be sent to attendees associated with at least one calendar event involved in the conflict. In some configurations, the data indicating the scheduling conflict is sent to the customer having the lowest priority of the customers involved in the conflict.

The computing device can generate data indicating a scheduling exception if the severity of a conflict does not meet or does not exceed a threshold level. The data indicating the scheduling exception can be in the form of a notification or message indicating one or more parameters related to the conflict. For instance, a message may indicate the presence of an overlapping meeting. A message or notification can also indicate that a meeting may be abridged in some manner. In some configurations, if the severity of a conflict does not meet or does not exceed a threshold level, the system can allow two conflicting calendar events to coexist. Although these examples utilize one or more threshold levels, it can be appreciated that techniques disclosed herein can utilize any suitable technology for analyzing data against any suitable criteria.

The techniques disclosed herein can prioritize customers and grant different levels of access to calendar data to individual customers based, at least in part, on an associated priority level. As will be described in more detail below, granting different levels of access based on a customer priority level enables high-priority customers to view, edit and reserve timeslots that may not be available to other customers.

The generation of different types of actions for customers having different priority levels, enables service providers or any other entity publishing a calendar can have influence on the type of customers that can schedule time on the published calendar. In addition, service providers or any other entity publishing a calendar can utilize the techniques disclosed herein to control the type of scheduling data that is published to customers and other computer users based, at least in part, on the contextual data and other data, such as the priority data.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

As will be described in more detail herein, it can be appreciated that implementations of the techniques and technologies described herein may include the use of solid state circuits, digital logic circuits, computer component, and/or software executing on one or more devices. Signals described herein may include analog and/or digital signals for communicating a changed state, movement and/or any data associated with motion detection. Gestures captured by users of the computing devices can use any type of sensor or input device.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

By the use of the technologies described herein, contextual data from a number of resources can be utilized to provide mechanisms for generating data defining contextually-aware scheduling exceptions. Such technologies can improve user interaction with a computing device by automatically suggesting recommendations that are contextually relevant to a relationship between two or more parties. Configurations can be beneficial in assisting users coordinating aspects of a project, such as calendar events, particularly when a user has a large number of events to schedule. Among many benefits provided by the technologies described herein, a user's interaction with a device may be improved, which may reduce the number of inadvertent inputs, reduce the consumption of processing resources, and mitigate the use of network resources. Other technical effects other than those mentioned herein can also be realized from implementations of the technologies disclosed herein.

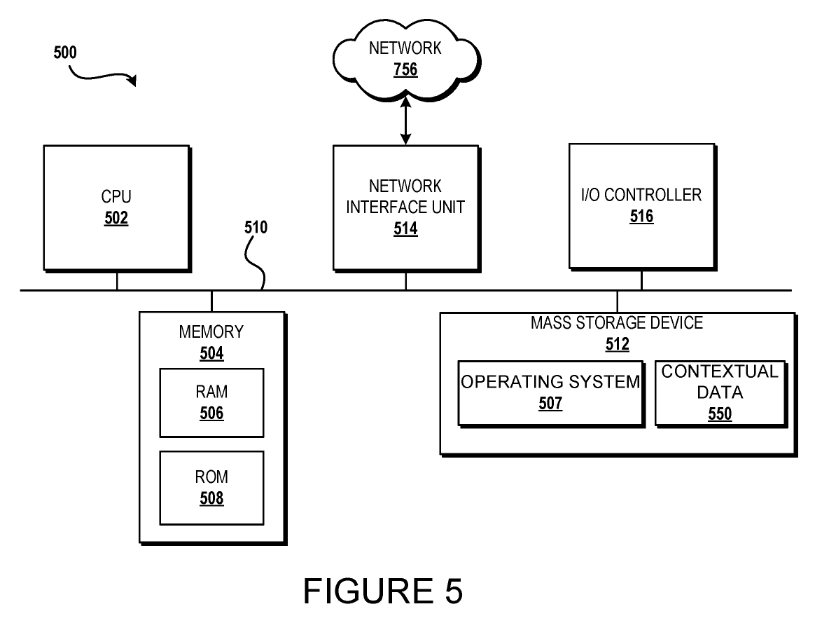

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for generating data defining contextually-aware scheduling exceptions. As will be described in more detail below with respect to FIGS. 5-7, there are a number of applications and services that can embody the functionality and techniques described herein.

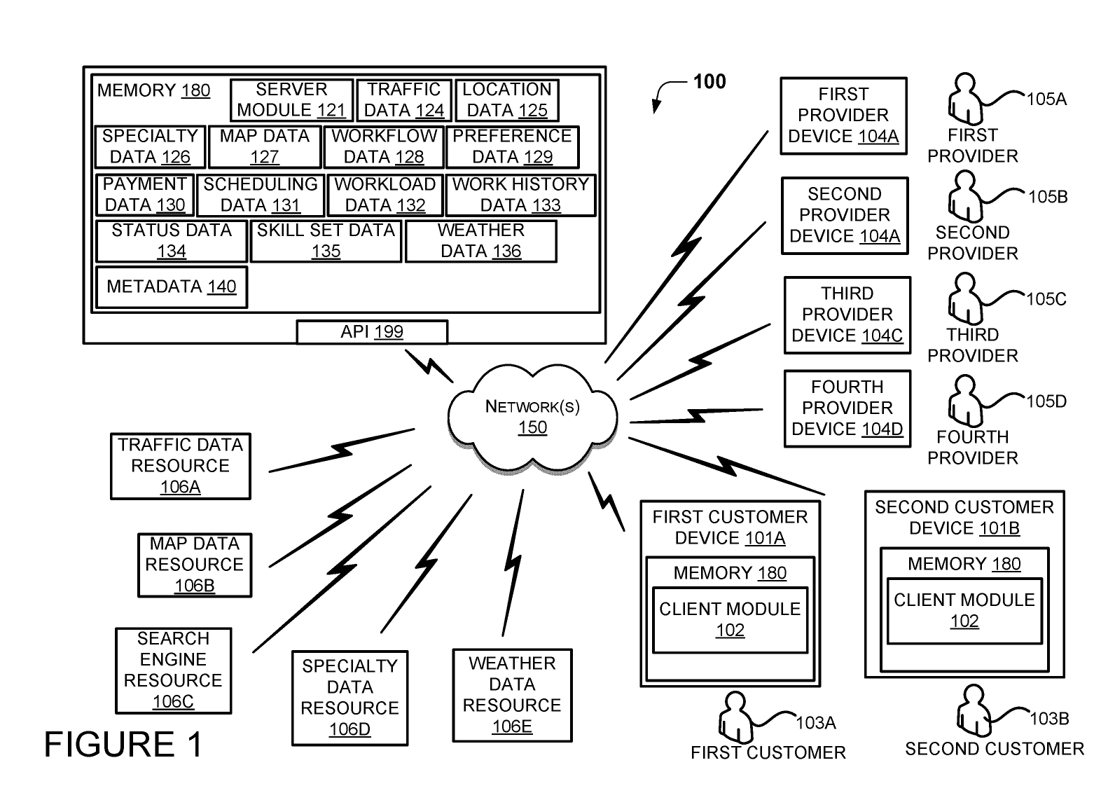

FIG. 1 is a block diagram showing aspects of one example environment 100, also referred to herein as a “system 100,” disclosed herein for generating data defining contextually-aware scheduling exceptions. In one illustrative example, the example environment 100 can include one or more servers 120, one or more networks 150, one or more customer devices 101A-101B (collectively “customer devices 101”), one or more provider devices 104A-104D (collectively “provider devices 104”), and one or more resources 106A-106E (collectively “resources 106”). The customer devices 101 can be utilized for interaction with one or more customers 103A-103B (collectively “customers 103”), and the provider devices 104 can be utilized for interaction with one or more service providers 105A-105D (collectively “service providers 105”). This example is provided for illustrative purposes and is not to be construed as limiting. It can be appreciated that the example environment 100 can include any number of devices, customers, providers, and/or any number of servers 120.

For illustrative purposes, the service providers 105 can be a company, person, or any type of entity capable of providing services or products for the customers 103, which can also be a company, person or other entity. For illustrative purposes, the service providers 105 and the customers 103 can be generically and individually referred to herein as “users.” In general, the techniques disclosed herein enable users to utilize contextual data from a number of resources 106 to generate workflow data 128 and other data objects related to the workflow data 128. In some configurations, a data object may include one or more calendar events related to stages of the workflow. Contextual data can be analyzed to determine one or more candidate timeslots for individual stages. The candidate timeslots can be ranked based on contextual data and a ranked list of candidate timeslots can be presented to the user for selection.

The customer devices 101, provider devices 104, servers 120 and/or any other computer configured with the features disclosed herein can be interconnected through one or more local and/or wide area networks, such as the network 150. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A customer device 101 or a provider device 104 (collectively “computing devices”) can operate as a stand-alone device, or such devices can operate in conjunction with other computers, such as the one or more servers 120. Individual computing devices can be in the form of a personal computer, mobile phone, tablet, wearable computer, including a head-mounted display (HMD) or watch, or any other computing device having components for interacting with one or more users and/or remote computers. In one illustrative example, the customer device 101 and the provider device 104 can include a local memory 180, also referred to herein as a “computer-readable storage medium,” configured to store data, such as a client module 102 and other contextual data described herein.

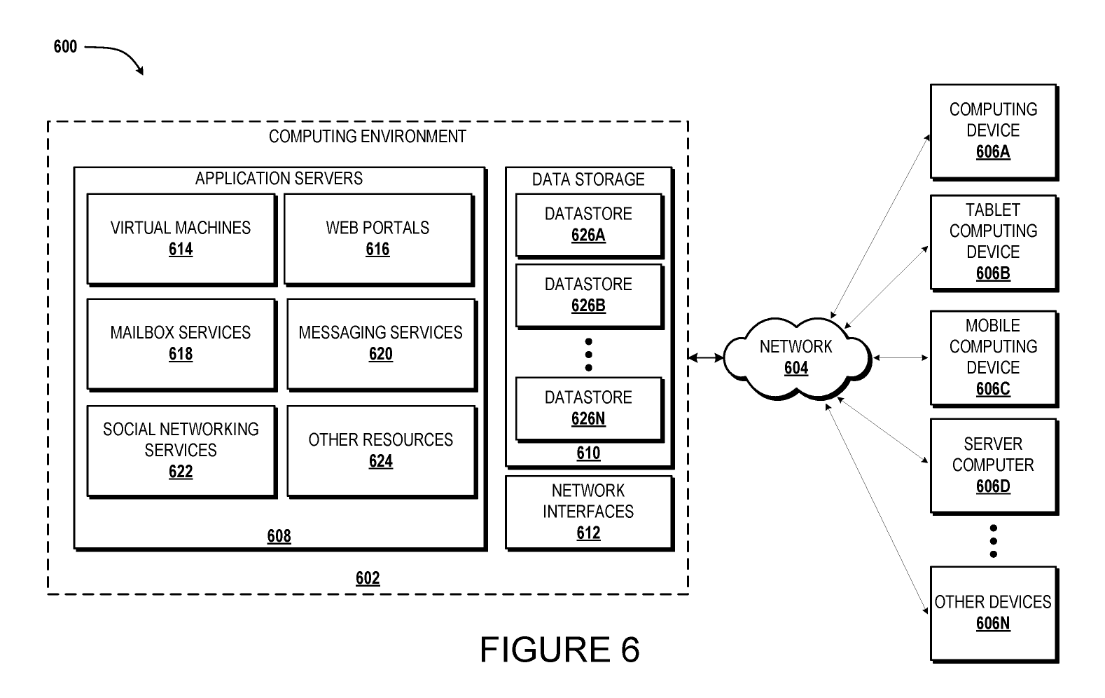

The servers 120 may be in the form of a personal computer, server farm, large-scale system or any other computing system having components for processing, coordinating, collecting, storing, and/or communicating data between one or more computing device. In one illustrative example, the servers 120 can include a local memory 180, also referred to herein as a “computer-readable storage medium,” configured to store data, such as a server module 121 and other data described herein. The servers 120 can also include components and services, such as the application services and shown in FIG. 6, for providing, receiving, and processing contextual data and executing one or more aspects of the techniques described herein. As will be described in more detail herein, any suitable module may operate in conjunction with other modules or devices to implement aspects of the techniques disclosed herein.

In some configurations, an application programming interface 199 (“API”) exposes an interface through which an operating system and application programs executing on the computing device can enable the functionality disclosed herein. Through the use of this data interface and other interfaces, the operating system and application programs can communicate and process contextual data to modify scheduling data as described herein.

The system 100 may include a number of resources, such as a traffic data resource 106A, map data resource 106B, search engine resource 106C, specialty data resource 106D, and a weather data resource 106E (collectively referred to herein as “resources 106”). The resources 106 can be a part of the servers 120 or separate from the servers 120, and the resources 106 can provide contextual data, including traffic data 124, location data 125, specialty data 126, map data 127, workflow data 128, preference data 129, payment data 130, scheduling data 131, workload data 132, work history data 133, status data 134, skill set data 135, weather data 136, and other data described herein. The metadata 140 can include, but is not limited to, a person's name, a company name, contact information, location data, and any other data related to a provider 105 or a customer 103. In some configurations, the metadata 140 can include any format suitable for populating one or more data entry fields of a user interface.

These example resources 106 and contextual data are provided for illustrative purposes and are not to be construed as limiting. It can be appreciated that the techniques disclosed herein may utilize more or fewer resources 106 shown in FIG. 1. It can also be appreciated that some of the resources shown in FIG. 1 can obtain any type of contextual information from other resources such as social networks, e-commerce systems, government systems, and other like sources. For instance, sales data from e-commerce systems can be used to determine a performance indicator of a customer or a provider.

The scheduling data 131 can define one or more attributes of one or more calendar events (also referred to as “appointments”) for the customers 103 and the providers 105. The scheduling data 131 can define a start time and an end time. The scheduling data 131 can also include location data 125 if an appointment is associated with a geographic location, global coordinates, an address, a room number and other information identifying a location. The scheduling data 131 can define a single appointment or a series of appointments. In addition, the scheduling data 131 can include communication information such as a phone number, IM address, URL, or other information for facilitating a voice or video conference. The scheduling data 131 can also include a text description of an appointment and other data indicating a topic, service category, a customer 103 and/or a provider 105. The scheduling data 131 can also include communication related to a calendar event, such as a request for a calendar event or an acceptance of a request for a calendar event. The scheduling data 131 can be stored on the server 120, customer device 101, provider device 104, or any suitable computing device, which may include a Web-based service.

The map data 127 can define roads and other types of travel paths within a geographic area. The map data 127 can also include topography data and other data that may influence a commute of a user from one location to another. The map data 127 can also include data defining buildings, homes, and other landmarks. The map data 127 can also include image data which may include a satellite image of the roads and paths within a geographic area as well as images of buildings, homes and other landmarks. The map data 127 may be from a number of resources, including a web-based service, government services, or other resources.

The traffic data 124 can include real-time updates on vehicle traffic within a geographic area. The traffic data 124 can also include historical travel data that can be used to predict travel times between two or more locations. The traffic data 124 can be in any suitable format for defining projected travel times between two or more locations that considers a time of travel, weather at a time of travel, traffic at a time of travel, and other factors that may influence a projected travel time. For example, the traffic data 124 can include updates with respect to road closures, delays, construction, new roads, or other scenarios that can impact activity with respect to a calendar event. The traffic data 124 may be from a number of resources, including a web-based service, government services, or other resources.

The weather data 136 can include current, historical, and forecast data indicating weather conditions. The weather data 136 can include data with respect to wind, precipitation, temperature and other conditions that may influence a commute from one location to another. The weather data 136 can be in any suitable format for enabling the projection of travel times between two or more locations. The weather data 136 may be from a number of resources, including a web-based service, government services, or other resources.

The specialty data 126 can include information pertaining to a specialization, subject, topic, one or more industries, or an area of interest. For example, specialty data 126 may include details relating to a medical topic, such as pediatrics, dentistry, etc. In other examples, the specialty data 126 may relate to diseases, cures, conditions, and other like topics. The specialty data 126 can be obtained from a number of different resources including web-based resources such as sites provided by WebMD, American Medical Association, and the Center of Disease Control. These examples are provided for illustrative purposes and are not to be construed as limiting, as the specialty data 126 can be related to any topic or areas of interest.

The workflow data 128 can define a multi-step process and attribute definitions within each step of the process. The workflow data 128 can be obtained from a number of different resources including web-based resources. In addition, the workflow data 128 can be derived from other data such as the specialty data 126. For example, specialty data 126 that pertains to pediatrics can be analyzed to determine a process that involves a number of steps which may include immunization shots, follow-up exams, and other milestones and tasks that are recommended at certain times.

The workload data 132 may include a listing of a number of services, projects, or appointments that are scheduled for a provider. For example, the workload data 132 may list a number of projects that are currently scheduled for a company. The workload data 132 can also be based on scheduling data 131, such as a number of appointments that are scheduled for a doctor. The workload data 131 can also define one or more thresholds. Such data can be used to determine if a company or individual is at, below, or above a given capacity. In some configurations, the workload data 132 defines a value indicating an ability of the individual provider relative to a predetermined workload capacity.

The skill set data 135 identifies and quantifies a range of skills and/or abilities of a particular company or individual. The skill set data 135 may include a hierarchy of data that identifies an industry, specializations within an industry, and details with respect to these specific projects that have been performed in the past. For instance, the skill set data 135 may identify a company as a construction company capable of performing particular types of renovations. The skill set data 135 may also provide details with respect to particular renovation projects and specialized features related to those projects. The skill set data 135 can apply to any company or individual related to any industry.

The work history data 133 can include performance indicators related to a provider 105 or a customer 103. For instance, the work history data 133 can indicate the quality of one or more projects performed by a provider 105. Work history data 133 can include an array of different performance indicators, which may relate to timeliness, productivity, accuracy, price, other indicators and combinations thereof. In other examples, the work history data 133 can indicate performance indicators associated with customers 103. In such examples, a customer 103 can be associated with an array of different performance indicators which may relate to a credit score or any other score associated with the behavior of a company, an individual or a group of individuals.

The payment data 130 can include a record of payments that are made between two or more parties. The payment data 130 can also include data indicating the timeliness in which payments are made. The payment data 130 can include a credit score or any other data that indicates a reliability and/or ability to make timely payments.

The status data 134 can define the availability of one or more parties. For instance, status data 134 can indicate if a party is unavailable, available, or unavailable until a particular date. The status data 134 can also define a level of availability. These examples are provided for illustrative purposes and are not to be construed as limiting. It can be appreciated that the status data 134 include a form of data indicating the availability of a company, an individual or a group of individuals.

The preference data 129 can include customer-defined preferences or provider-defined preferences. In some configurations, the preference data 129 can include a number of weighted parameters that indicate priorities, preferences, and/or goals. For instance, a provider 105 may indicate that they are interested in identifying customers that are timely with respect to appointments. In other examples, a provider 105 may indicate that they are interested in customers having good credit or customers that may have a particular payment history. In some configurations, provider-defined preferences can include a combination of parameters and/or priorities enabling the system 100 to identify, select, and rank customers having a long-term value or a short-term value to a provider. In one illustrative example, provider-defined preferences may identify a number of performance metrics with respect to customers and each performance metric can be weighted to enable a provider 105 to identify customers having a “high lifetime value.” Such preferences can be configured for providers desiring to acquire customers that can benefit their company with respect to long-term goals. The preference data 129 can include provider-defined preferences enabling the system 100 to identify, select, and rank high-volume customers, high-profile customers, and other types of customers or users that fit one or more business models. In addition to identifying preferred customers, the techniques disclosed herein can also enable a provider to “fire,” e.g., terminate a relationship with, unwanted customers.

In some configurations, the preference data 129 can help customers identify and/or terminate providers. In some configurations, customer-defined preferences may indicate they are interested in identifying providers 105 having a particular quality rating. The preference data 129 can also include other data to indicate a combination of parameters, goals, and/or priorities. For instance, the preference data 129 can include customer-defined preferences enabling the system 100 to identify, select, and rank high-volume providers, high-profile providers, and other types of providers that meet the needs of a customer.

The preference data 129 can also define a value indicating a level of “interruptability” of a particular project, job, appointment, or event. As will be described in the examples provided herein, a customer 103 or a provider 105 can indicate if a particular calendar event can be interrupted by other calendar event proposals. Such features enable the techniques disclosed herein to resolve conflicts between calendar events and identify alternative plans if conflicts arise.

It can be appreciated that a level of interruptability, priority or other preferences for a calendar event can be from a number of sources. For instance, a priority or a level of interruptability can be communicated when a calendar event is created. In some configurations, a priority for a calendar event can be based on a priority indicated by a sender of a calendar event. In such an example, a user entering input data can indicate a priority or a level of interruptability. In addition, a priority for a calendar event can be based on a priority established by a recipient of the calendar event. In such an example, a recipient may accept an invitation for an appointment and provide input data indicating a priority and/or a level of interruptability. A priority and/or a level of interruptability can also be a combination of inputs from the sender and recipient of a calendar event.

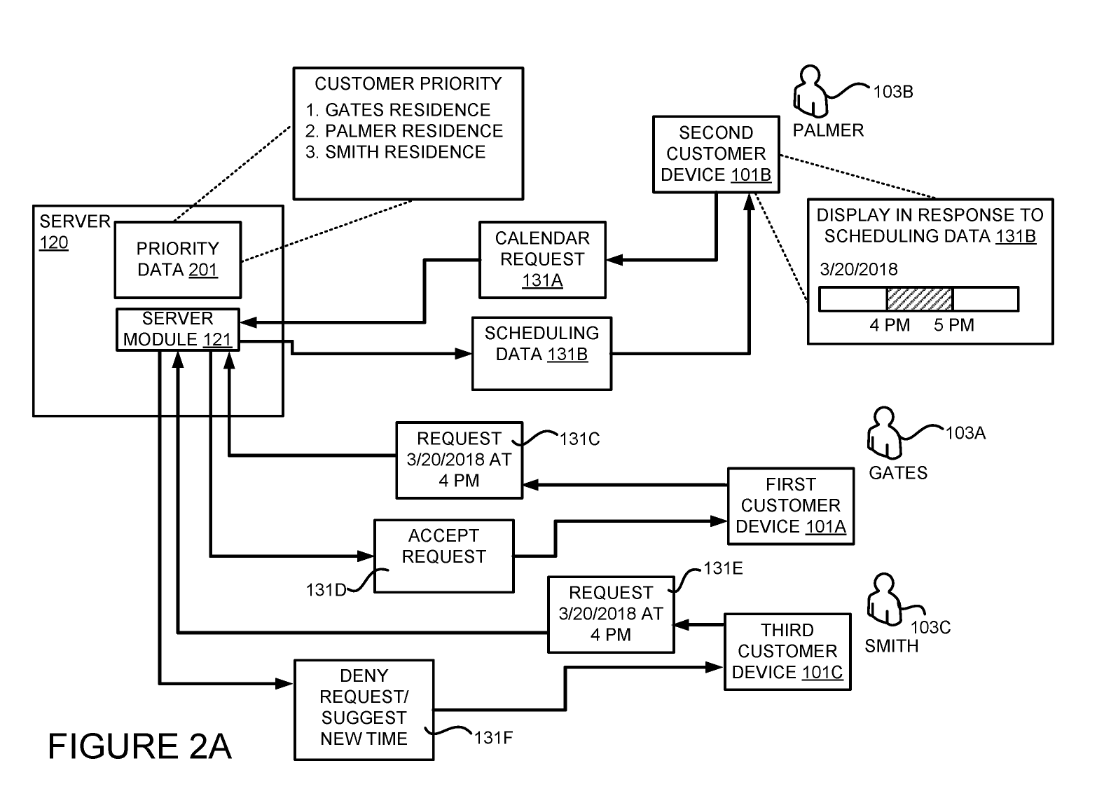

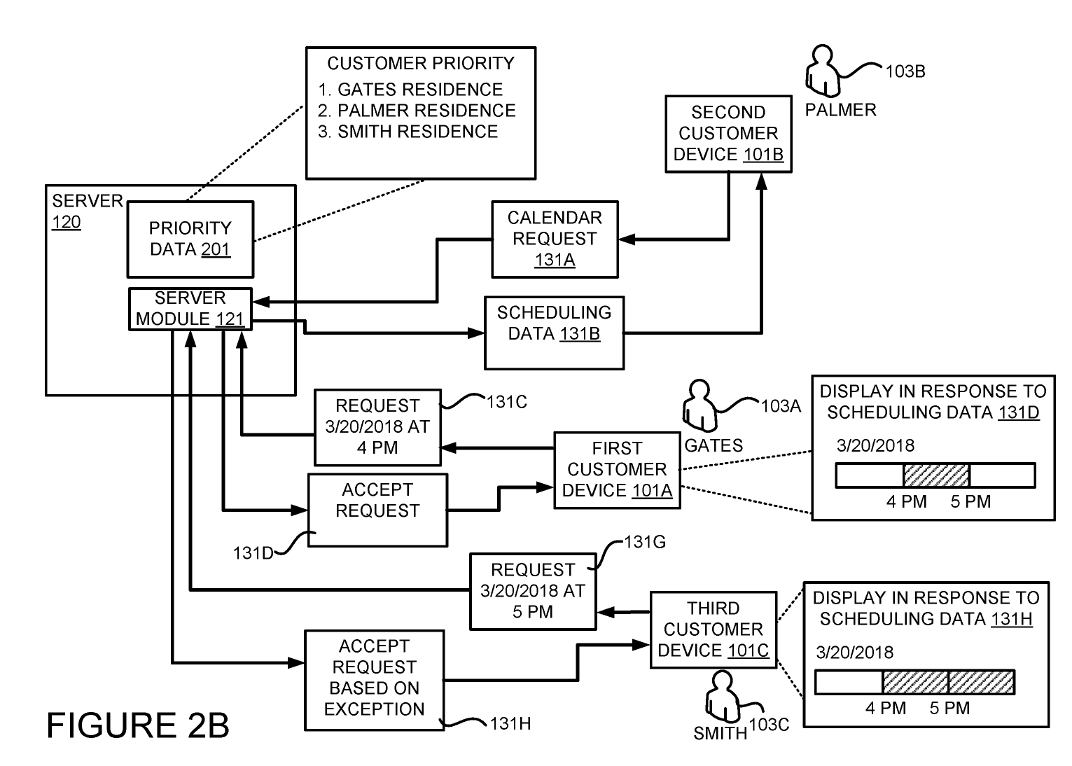

Turning now to FIGS. 2A-2B, block diagrams showing an illustrative example of data defining a scheduling conflict and data defining a scheduling exception are shown and described below. In this illustrative example, a number of customers are prioritized based on an analysis of contextual data. The contextual data can include preference data, such as provider-defined preferences. The preferences can include one or more goals, and the goals can be based on a number of parameters. For instance, a service provider may define a goal to rekindle relationships with old customers, find new customers of a particular market segment, or identify customers having a particular credit score. One or more suitable technologies can be used to analyze contextual data and prioritize customers based on such preference data. The example of FIGS. 2A-2B illustrate aspects of such techniques.

As shown in FIG. 2A, priority data 201 defines a priority for a number of customers. In this example, the Gates are rated as a first priority, the Palmers are rated as a second priority, and the Smiths are rated as a third priority. This example is provided for illustrative purposes and is not to be construed as limiting. It can be appreciated that any number of customers can be ranked, and in some configurations, the ranking of some customers can include a weighted score. It can also be appreciated that such a ranking process can apply to different types of users, including process for ranking of a number of providers. Additional details regarding the generation of data defining priorities for one or more entities, such as a customer, is described in more detail below.

In the illustrative example of FIG. 2A, the second customer 103B, Palmer, sends a calendar request 131A to the server 120 to establish a calendar event. In this example, the request 131A establishes a first calendar event for Mar. 20, 2018 starting at 4 PM and ending at 5 PM. In response to the request 131A, the server 120 sends scheduling data 131B, e.g., a confirmation, to the second customer 103B. The second customer device 101B can be used to display the established calendar event, as shown in FIG. 2A.

In the current example, after the first calendar event is established, the first user 103A, Gates, sends a second request 131C to the server 120 establish a second calendar event for the same time slot. Upon receipt of the second request 131C, the server 120 analyzes contextual data, including the scheduling data associated with the first calendar event and the second calendar event. In this example, since the calendar events completely overlap, the severity of the conflict is high.

As summarized above, some configurations can generate different values indicating a severity of conflict based on a user's priority. In the current example, the system generates data indicating that the severity of the conflict is below a threshold for the high priority customer, e.g., Gates. In such a scenario, the system may generate a message 131D for the high priority customer, Gates, indicating that the system accepts the parameters of the second request 131C. In this case, the system makes an exception for the high priority customer. At the same time, the system can also generate data indicating that the severity of the conflict is above a threshold for the low priority customer, e.g., Palmer. In such an example, additional scheduling data 131B can be sent to the first second customer device 101B indicating a cancellation of the first calendar event associated with Palmer. In such a scenario, the system may allow first calendar event to coexist with the second calendar event but the lower priority customer, Palmer, may receive a notification that their calendar event is accepted as tentative. The tentative acceptance may be converted to a full acceptance if the higher priority customer cancels the second calendar event.

The above-described example continues where a third customer 103C, Smith, sends a third request 131E for a calendar event scheduled for the same time slot. In this example, the severity of the conflict may be high for the third customer 103C given that the priority for the third customer 103C is lower than the other customers. In such an example, the system may automatically generate a message 131F indicating the conflict. As shown in FIG. 2A, the message 131F may indicate that the system has denied the third request 131E. The system may also generate other scheduling data 131, such as a new calendar event suggesting a new time.

FIG. 2B illustrates a variation to the example shown in FIG. 2A. In this example, after the first customer 103A establishes a calendar event for 4:00 PM on 3/20/2018, the third customer 103C, Smith, sends a request 131G for a calendar event at 5:00 PM on the same day. In this example, the system can analyze the contextual data, which may include traffic data, location data, weather data, and map data, to determine a severity of a conflict. In this example, if the two appointments are to be held in different locations with a low probability of a successful commute, the system may determine that the severity of the conflict exceeds one or more thresholds. Such a result may occur on traffic conditions, and other data indicates a low probability of a successful commute. However, in this example, if the two appointments are held in locations where the probability of a successful commute is high, the severity of a conflict may not exceed one or more thresholds. In such an example, the system may determine that even if a conflict exists the system can make an exception and allow the two calendar events to coexist. Even if the severity of the conflict does not reach a threshold, any type of conflict, regardless of the severity level, can also cause a system to generate messages indicating the circumstances of the conflict. As shown in FIG. 2B, scheduling data 131H sent to the third customer device 101C indicates an acceptance of the request 131G, the scheduling data 131H can also provide an indication of the exception with a description of the circumstances.

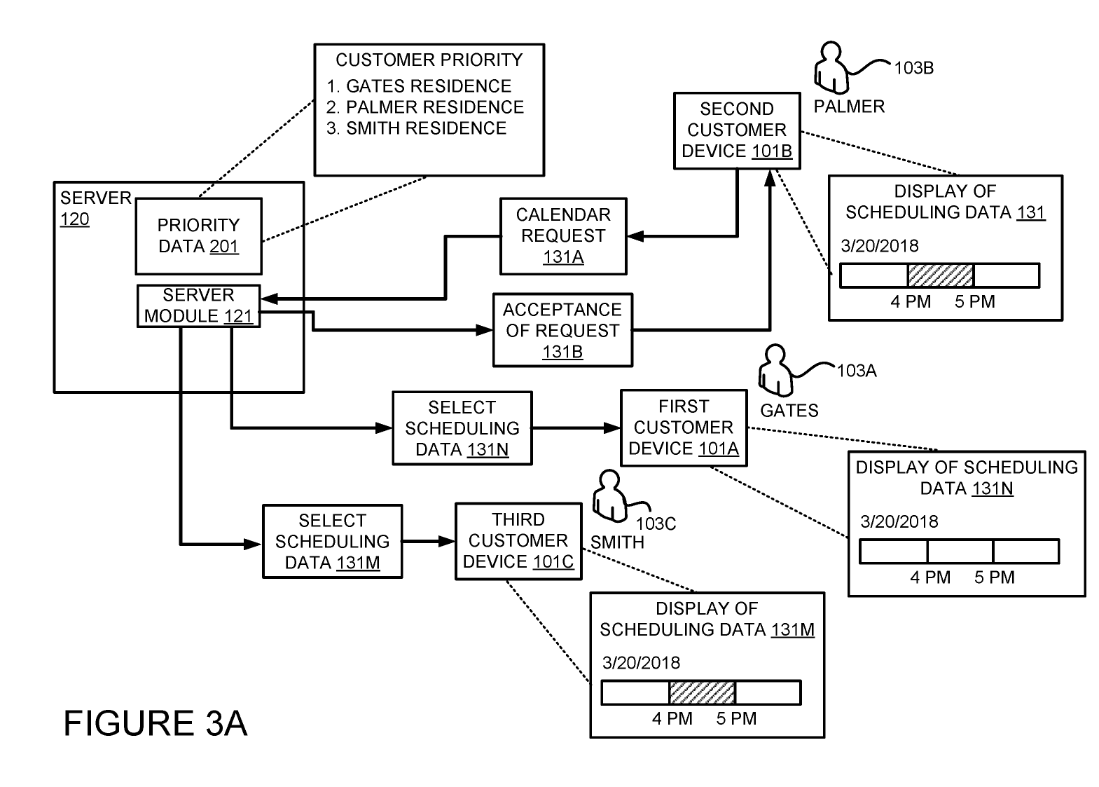

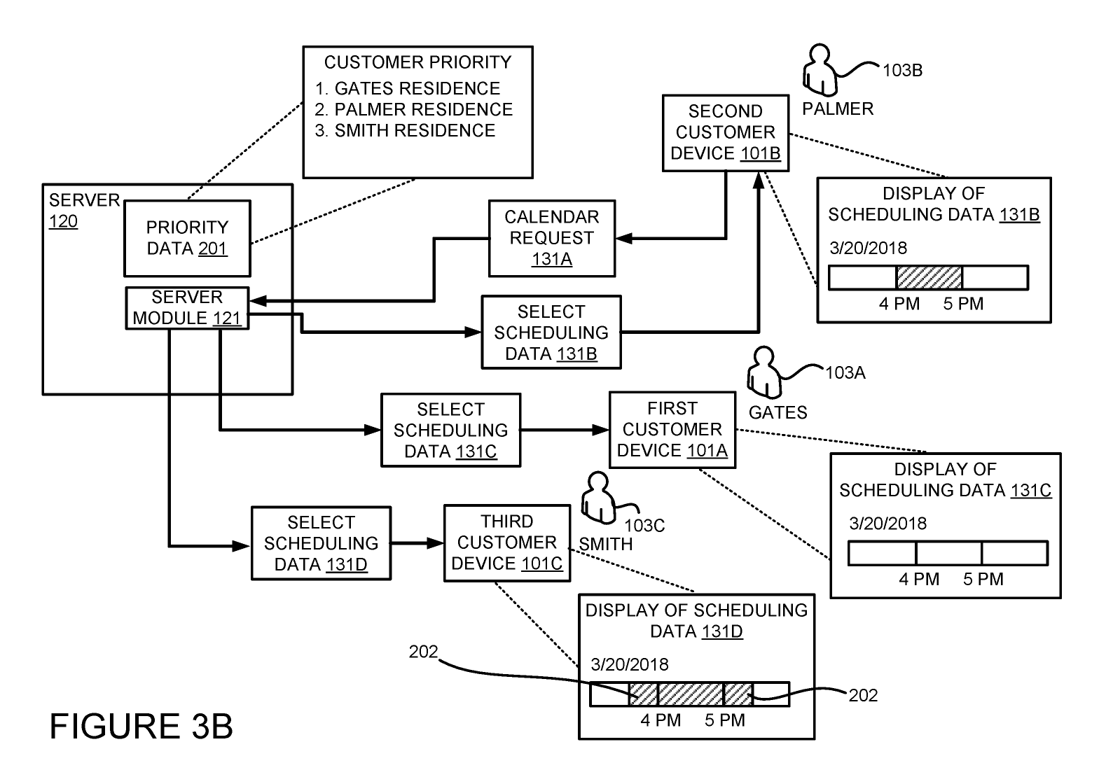

As summarized above, the techniques disclosed herein can prioritize customers and grant different levels of access to calendar data to individual customers based, at least in part, on an associated priority level. As shown in the examples of FIG. 3A and FIG. 3B, configurations granting different levels of access based on a customer priority level enables high-priority customers to view, edit and reserve timeslots that may not be available to other customers.

Referring now to FIG. 3A, the server 120 stores priority data 201 and one indicating the sample priority list described above. In this example, the Gates are rated as a first priority, the Palmers are rated as a second priority, and the Smiths are rated as a third priority. Similar to the example above, the second customer 103B, Palmer, establishes a calendar event for 4 PM on Mar. 20, 2018.

After the calendar event is established, in this example, the first customer 103A, Gates, sends a query to the server 120 to view the scheduling data of the service provider. Based on the priority of the first customer 103A relative to the priority of the second customer 103B, the server 100 sends select scheduling data 131N to the first customer 103A. In this example, since the first customer 103A as a higher priority than the second customer 103B, the select scheduling data 131N does not show the established calendar events for lower priority customers. Specifically, the calendar event established for Palmer is not displayed. This feature enables service providers to grant more flexibility in a published schedule to higher priority customers. For instance, if the first customer 103A is a high-value, high-volume customer, a service provider can show more available slots to increase the probability that they will schedule a time. In addition, lower priority customers will see different results.

In the present example of FIG. 3A, the third customer 103C, has a lower priority than the second customer 103B. Thus, the select scheduling data 131M that is sent to the third customer device 101C, indicates that the timeslot reserved for the second customer 103B is not available.

The techniques disclosed herein can also generate enhanced scheduling data 131 to improve relationships with higher priority customers. One example of this feature is shown in FIG. 3B. In this example, the calendar event established by the second customer 103B is scheduled for a timeslot between 4 PM and 5 PM on Mar. 30, 2018. When the priority data 201 indicates that a priority for a particular customer exceeds a threshold, additional actions may be taken. In this example, one additional action involves the generation of enhanced scheduling data 131 that reserves time around appointments for the higher priority customers. In this example, the calendar event scheduled between 4 PM and 5 PM is surrounded by other reservations to allocate more time for the higher priority customer. One or more graphical elements 202 can be displayed around the calendar event to reduce the probability of a scheduling conflict for the second customer 103B. As shown in this example, highest priority customer, the first customer 103A, does not receive data showing the calendar event or the enhanced scheduling data 131.

These examples are provided for illustrative purposes and they are not to be construed as limiting. It can be appreciated that other contextual data can be utilized to determine the severity of a conflict. It can also be appreciated that such examples can involve a priority list associating one or more priorities with individual service providers.

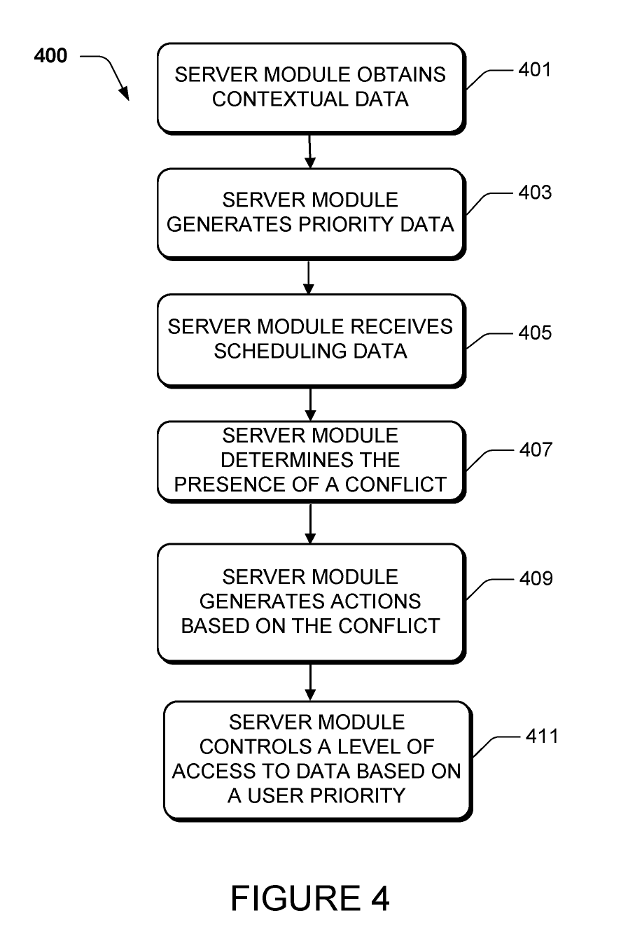

Turning now to FIG. 4, aspects of a routine 400 for providing contextually-aware scheduling exceptions. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As will be described in more detail below, in conjunction with FIG. 1, the operations of the routine 400 are described herein as being implemented, at least in part, by an application, component, and/or circuit. Although the following illustration refers to the components of FIG. 1, it can be appreciated that the operations of the routine 400 may be also implemented in many other ways. For example, the routine 400 may be implemented, at least in part, by computer processor or processor of another computer. In addition, one or more of the operations of the routine 400 may alternatively or additionally be implemented, at least in part, by a computer working alone or in conjunction with other software modules, such as the server module 121.

With reference to FIG. 4, the routine 400 begins at operation 401, where the server module 121 obtains contextual data. As described herein, the contextual data can be obtained from a number of different resources. For example, contextual data can be obtained from a traffic data resource 106A, map data resource 106B, search engine resource 106C, specialty data resource 106D, and a weather data resource 106E, and/or other resources suitable for storing, processing, and/or communicating contextual data.

The contextual data can be related to service providers and/or consumers. The contextual can include, for example, data defining a prior work history between two or more entities, payment histories, credit histories, an availability of one or more parties, a location of a project, travel time to an appointment, traffic data, skill set data, preferred business hours, scheduling availability, performance metrics, scheduling conflicts, customer preferences, vendor preferences, workflow definitions, other data, and combinations thereof. The techniques disclosed herein can also quantify a value of a customer or a value of a vendor. Such contextual data can be received from one or more resources or such contextual data can be derived from other types of contextual data. For instance, data defining a lifetime value of a customer or a lifetime value of a provider can be generated from payment histories, credit histories, and other information.

The contextual data can also include specialty data 126 pertaining to a specialization, subject, topic, one or more industries, or an area of interest. For example, specialty data 126 may include details relating to a medical topic, such as pediatrics, dentistry, etc. In other examples, the specialty data 126 may relate to diseases, cures, conditions, and other like topics. These examples are provided for illustrative purposes and are not to be construed as limiting, as the specialty data 126 can be related to any topic or areas of interest. As summarized above, such contextual data can be utilized for prioritizing customers for service providers.

Next, at operation 403, the server module 121 generates priority data 201. As summarized above, the priority data 201 may include one or more values that indicate a priority for individual customers for service providers. In a scenario where a service provider is searching for customers within a particular segment, one or more goals can be defined by the service provider and contextual data related to each customer can be analyzed to determine a priority for each customer. The goals may be related to a customer's credit history, payment history, and/or status. These examples are provided for illustrative purposes and are not to be construed as limiting. It can be appreciated that any goal or criteria defined by a provider can be utilized by the techniques disclosed herein.

In some configurations, operation 403 can include generating priority data indicating a priority of individual customers of the plurality of customers, wherein the priority is based, at least in part, on an analysis of contextual data. The contextual data can include, but is not limited to, traffic data 124, location data 125, specialty data 126, map data 127, workflow data 128, preference data 129, payment data 130, scheduling data 131, workload data 132, work history data 133, status data 134, skill set data 135, weather data 136, and other data described herein.

In some configurations, the priority of the individual customers can be based, at least in part, on a degree of alignment of attributes of the work history data to one or more goals defined in preference data. For example, a provider can provide preferences defining one or more goals defining thresholds. The one or more goals can include a goal of rekindling relationships with customers, finding high-value customers, identifying high-profile customers, identifying customers with good credit, etc. A goal defining one or more thresholds, parameters, or values can be utilized in the techniques disclosed herein.

The work history data for example can include attributes such as contact information for one or more customers as well as a description of a work history with such customers. The work history data can include attributes that indicate a time and date when the provider has worked with individual customers as well as a one or more data points quantifying the value of each customer. Work history data can also include payment data, which indicates a frequency, amount, or other parameters relating to a customer's payment history. The customers can be individually ranked or prioritized based on the alignment of the work history data and other contextual data with the preferences. For example, the preferences may identify a goal of identifying customers with good credit, individual customers can be ranked based on their credit scores and/or payment history. If a provider is looking for a goal to rekindle relationships with customers, one or more techniques for analyzing work history data may prioritize customers based on a last date in which the provider worked with a particular customer. A priority of the customer may also be based on the amount of revenue a customer generates, which may include revenue within a particular time, such as monthly period, annual period, or other period.

When multiple goals are defined in the preference data, combinations of different performance metrics, such as a combination of credit scores and annual revenue figures, can be used to prioritize customers. The individual performance metrics can be weighted based on a desired outcome. For example, when a priority for a particular customer is calculated, that customer's credit score may influence 90% the priority calculation and the revenue figures may only influence 10% of the priority calculation.

Skill set data and specialty data may also be utilized to determine a priority for a particular customer. For example, if a provider has a particular specialty, such as transmission repair, and a first customer is looking for a provider to fix brakes, a priority with respect to the first customer may be lower than a second customer for a provider to fix a transmission.

Next, at operation 405, the server module 121 receives scheduling data 131. The scheduling data 131 may be in any suitable format, such as a request for a calendar event. Examples of such scheduling data are shown in FIG. 2A, FIG. 2B, FIG. 3A and FIG. 3B.

Next, at operation 407, the server module 121 can determine the presence of a conflict. As summarized above, a conflict may be detected number of different techniques. For example, the presence of scheduling data 131 defining two overlapping calendar events can cause the server module 121 to detect the presence of a conflict. In another example, scheduling data 131 defining two calendar events that are adjacent to one another can cause the server module 121 to detect the presence of a conflict if a probability of a commute between the two calendar events falls below one or more thresholds. In operation 407, the server module 121 can also generate data defining a severity of a conflict. The severity of a conflict can be based on an analysis of the contextual data, which may include priority data 201.

Next, at operation 409, the server module 121 can take one or more actions based on the data related to the conflict. In one example, configurations can generate data indicating the scheduling conflict if the severity of a conflict meets or exceeds a threshold level. The data indicating the scheduling conflict can be in the form of a notification or message. In some cases, the data indicating the scheduling conflict can be a new calendar event recommending an alternative time. In some configurations, the data indicating the scheduling conflict can be a “decline” notification that is sent in response to a meeting request. The data indicating the scheduling conflict can be sent to attendees associated with at least one calendar event involved in the conflict. In some configurations, the data indicating the scheduling conflict is sent to the customer having the lowest priority of the customers involved in the conflict.

The computing device can generate data indicating a scheduling exception if the severity of a conflict does not meet or does not exceed a threshold level. The data indicating the scheduling exception can be in the form of a notification or message indicating one or more parameters related to the conflict. For instance, a message may indicate the presence of an overlapping meeting. A message or notification can also indicate that a meeting may be abridged in some manner. In some configurations, if the severity of a conflict does not meet or does not exceed a threshold level, the system can allow two conflicting calendar events to coexist.

Next, at operation 411, the server module 121 can control levels of access to calendar data to individual customers or individual providers based, at least in part, on an associated priority level. As described herein, granting different levels of access based on a customer priority level enables high-priority customers to view, edit and reserve timeslots that may not be available to other customers. Examples of graphical user interfaces illustrating different levels of access to scheduling data 131 are shown in FIG. 3A and FIG. 3B.

As summarized above, a number of factors derived from the contextual data can be utilized to prioritize customers and service providers. In addition, a number of factors derived from the contextual data can be utilized to determine the severity of a conflict. The following section describes illustrative examples of how contextual data can be used to influence a value quantifying the severity of a conflict and/or a value quantifying the priority of a user, e.g., a customer or a provider.

When the analysis of contextual data involves preference data, the analysis can interpret and process a number of different goals at any given time. Thus, customer goals and provider goals can be achieved simultaneously. For example, if a particular provider has certain goals that indicate a need for certain types of customers, performance data associated with a customer can be utilized to influence a priority associated with a customer. At the same time, if a customer has several goals relating to timeliness and quality, data defining performance indicators for providers that help achieve such goals can be utilized to influence a priority associated with a customer. The priority of a customer or a provider can be based on a value determined by any suitable technique for aligning performance data and one or more goals.

The priority of a customer can be based on the availability and/or interruptability associated with one or more entities. For example, if the system 100 analyzes scheduling data 131 of a customer and it appears that the customer's schedule does not align with a provider's schedule, data quantifying such an alignment can be utilized to influence a priority associated with a customer. In addition, if the customer appears to have a threshold amount of calendar events having a predetermined degree of interruptability, data resulting from such an analysis can be utilized to influence a priority associated with a customer.

In some configurations, the priority of a customer can be based, at least in part, on an alignment between specialty data, skill set data. For instance, if a calendar request indicates a need for a dishwasher repair expert, and skill set data associated with a provider indicates that the provider's skill set does not align with a described task or need, the system 100 may lower the priority of a customer associated with such a calendar request. The alignment between skill set data and goals defined by a customer can also increase the priority of a customer.

In some configurations, the priority of a customer can be based, at least in part, on the analysis of location data 125, map data 127, weather data 136, and/or traffic data 124. For instance, a customer associated with a shorter commute or a higher probability of a commute may have a higher priority than a customer associated with a longer commute or a lower probability of a commute. Such an analysis may involve map data, weather data, and other data to determine projections of commute times, a probability of a commute, and/or a degree of difficulty of a commute. The analysis of location data 125, map data 127, weather data 136, and/or traffic data 124 can also influence the generation of data defining a severity of a conflict. A severity of a conflict can be raised or lowered depending on how weather, traffic or other factors influence a probability of a commute.

In one illustrative example, if a consumer has two appointments that are adjacent to one another, a probability associated with the consumer's commute between the appointments can influence the priority of that customer. For example, if the customer's scheduling data 131 indicates that the consumer only has 20 minutes to commute to the location of a particular provider, the map data 127, traffic data 124, and other contextual data can be analyzed to determine if that commute is possible within the given timeframe. A probability of a commute can be determined for a number of customer's, and each customer may be prioritized based on such generated data. In addition, one or more customers can be removed from the priority data 201 if the probability does not meet or exceed one or more thresholds. Removal of a customer from a list enables a provider to schedule less time or eliminate a relationship with a customer.

In some configurations, one or more devices and/or the server 120 can generate projections to determine if a user or provider can make an appointment based on traffic patterns. For instance, if the appointment is scheduled for a weekday during rush hour, the techniques disclosed herein can change the priority of a customer if a commute associated with that customer is impacted by such traffic conditions. Such an analysis can be influenced by a forecast defined in weather data 136. For example, if weather data 136 indicates a favorable forecast, the priority of a customer impacted by such a forecast can increase. In addition, if weather data 136 indicates an unfavorable forecast, the priority of a customer impacted by such a forecast can decrease.

In some configurations, the analysis of payment data 130, work history data 133, skill set data 135, workflow data 128, workload data 132 and/or other contextual data can influence a priority of a customer. For instance, if a customer is looking for a provider having certain qualities, such as high performance ratings, a customer having such preferences that align with the provider publishing calendar data can have an increased priority. In addition, if a provider is looking for a customer having certain qualities, such as a high credit score or a preferred payment history, a customer having such qualities can have an increased priority.

In some configurations, work history data 133 can define the status of a relationship between two or more entities. For instance, if a customer and a provider are currently working on a project, the priority of such a customer can be increased. If the provider and the customer have not worked together for some time, the priority of such a customer can be increased or decreased depending on a desired outcome. For instance, if a customer having a high lifetime value, such as Bill Gates, desires to set an appointment with a provider, providers seeking such customers can provide preference data causing the system to increase the priority of such customers. In another example, if preference data of a patient indicates a desire to work with a doctor or other provider having a certain status, e.g., a top 10 specialist, providers seeking such customers can provide preference data causing the system to increase the priority of such customers.

FIG. 5 shows additional details of an example computer architecture 500 for a computer, such as the computing device 101 (FIG. 1), capable of executing the program components described herein. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein. 101051o The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 507 and other data, such as the contextual data 550.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 756 and/or another network (not shown). The computer architecture 500 may connect to the network 756 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

FIG. 6 depicts an illustrative distributed computing environment 600 capable of executing the software components described herein for providing contextually-aware scheduling exceptions. Thus, the distributed computing environment 600 illustrated in FIG. 6 can be utilized to execute any aspects of the software components presented herein. For example, the distributed computing environment 600 can be utilized to execute aspects of the software components described herein.

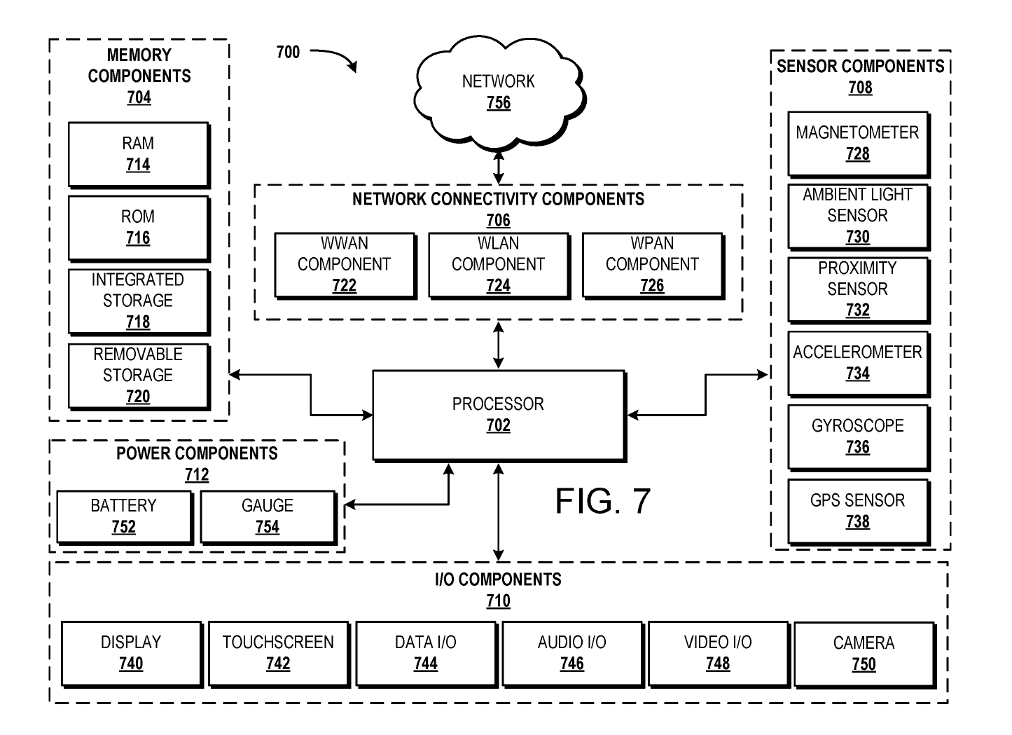

According to various implementations, the distributed computing environment 600 includes a computing environment 602 operating on, in communication with, or as part of the network 604. The network 604 may be or may include the network 756, described above with reference to FIG. 5. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In one illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing contextually-aware scheduling exceptions. It should be understood that this configuration is illustrative, and should not be construed as being limiting in any way. The application servers 608 also host or provide access to one or more portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also may include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above configurations are illustrative, and should not be construed as being limited in any way. According to various implementations, the social networking services 622 may host one or more applications and/or software modules for providing the functionality described herein. For instance, any one of the application servers 608 may communicate or facilitate the functionality and features described herein. For instance, a social networking application, mail client, messaging client or a browser running on a phone or any other client 606 may communicate with a networking service 622 and facilitate the functionality, even in part, described above with respect to FIG. 4.

As shown in FIG. 6, the application servers 608 also can host other services, applications, portals, and/or other resources (“other resources”) 624. The other resources 624 can include, but are not limited to, document sharing, rendering or any other functionality. It thus can be appreciated that the computing environment 602 can provide integration of the concepts and technologies disclosed herein provided herein with various mailbox, messaging, social networking, and/or other services or resources.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual data stores 626A-626N (hereinafter referred to collectively and/or generically as “data the one or more performance metrics stores 626”). The data stores 626 are configured to host data used or created by the application servers 608 and/or other data. Although not illustrated in FIG. 6, the data stores 626 also can host or store web page documents, word documents, presentation documents, data structures, algorithms for execution by a recommendation engine, and/or other data utilized by any application program or another module. Aspects of the data stores 626 may be associated with a service for storing files.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 600 to utilize the functionality described herein for providing contextually-aware scheduling exceptions, among other aspects. In one specific example, as summarized above, techniques described herein may be implemented, at least in part, by a web browser application, which can work in conjunction with the application servers 608 of FIG. 6.

Turning now to FIG. 7, an illustrative computing device architecture 700 for a computing device that is capable of executing various software components described herein for providing contextually-aware scheduling exceptions. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 700 is applicable to any of the clients 606 shown in FIG. 6. Moreover, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 604 of FIG. 6. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited, Wi-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The magnetometer 728 is configured to measure the strength and direction of a magnetic field. In some configurations the magnetometer 728 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 728 are contemplated.

The ambient light sensor 730 is configured to measure ambient light. In some configurations, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some configurations, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some configurations, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some configurations, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some configurations, output from the gyroscope 736 is used by an application program as an input mechanism to control some functionality of the application program. For example, the gyroscope 736 can be used for accurate recognition of movement within a 3D environment of a video game application or some other application. In some configurations, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 740 is a liquid crystal display (“LCD”) utilizing any active or passive matrix technology and any backlighting technology (if used). In some configurations, the display 740 is an organic light emitting diode (“OLED”) display. Other display types are contemplated.

The touchscreen 742, also referred to herein as a “touch-enabled screen,” is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 742 is incorporated on top of the display 740 as a transparent layer to enable a user to use one or more touches to interact with objects or other information presented on the display 740. In other configurations, the touchscreen 742 is a touch pad incorporated on a surface of the computing device that does not include the display 740. For example, the computing device may have a touchscreen incorporated on top of the display 740 and a touch pad on a surface opposite the display 740.

In some configurations, the touchscreen 742 is a single-touch touchscreen. In other configurations, the touchscreen 742 is a multi-touch touchscreen. In some configurations, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application program.

In some configurations, the touchscreen 742 supports a tap gesture in which a user taps the touchscreen 742 once on an item presented on the display 740. The tap gesture may be used for various reasons including, but not limited to, opening or launching whatever the user taps. In some configurations, the touchscreen 742 supports a double tap gesture in which a user taps the touchscreen 742 twice on an item presented on the display 740. The double tap gesture may be used for various reasons including, but not limited to, zooming in or zooming out in stages. In some configurations, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some configurations, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some configurations, the touchscreen 742 supports a flick gesture in which a user swipes a finger in the direction the user wants the screen to move. The flick gesture may be used for various reasons including, but not limited to, scrolling horizontally or vertically through menus or pages. In some configurations, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a web site, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limiting in any way.

The data I/O interface component 744 is configured to facilitate input of data to the computing device and output of data from the computing device. In some configurations, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 746 is configured to provide audio input and/or output capabilities to the computing device. In some configurations, the audio I/O interface component 746 includes a microphone configured to collect audio signals. In some configurations, the audio I/O interface component 746 includes a headphone jack configured to provide connectivity for headphones or other external speakers. In some configurations, the audio I/O interface component 746 includes a speaker for the output of audio signals. In some configurations, the audio I/O interface component 746 includes an optical audio cable out.

The video I/O interface component 748 is configured to provide video input and/or output capabilities to the computing device. In some configurations, the video I/O interface component 748 includes a video connector configured to receive video as input from another device (e.g., a video media player such as a DVD or BLURAY player) or send video as output to another device (e.g., a monitor, a television, or some other external display). In some configurations, the video I/O interface component 748 includes a High-Definition Multimedia Interface (“HDMI”), mini-HDMI, micro-HDMI, DisplayPort, or proprietary connector to input/output video content. In some configurations, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some configurations, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some configurations, the battery gauge 754 is configured to measure the effect of a battery's discharge rate, temperature, age and other factors to predict remaining life within a certain percentage of error. In some configurations, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via an I/O component.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method comprising:
receiving, at a computing device, scheduling data defining a first calendar event associated with a first customer of a plurality of customers;
receiving, at the computing device, scheduling data defining a second calendar event associated with a second customer of the plurality of customers;
generating priority data indicating a priority of individual customers of the plurality of customers, wherein the priority is based, at least in part, on an analysis of contextual data including work history data, wherein the priority of the individual customers is based, at least in part, on a degree of alignment of attributes of the work history data and one or more goals defined in preference data;
generating one or more values indicating a severity of a conflict based, at least in part, on the contextual data, including the priority data;
determining if the one or more values indicating the severity of the conflict meet one or more criteria; and
generating data indicating an exception to the conflict if the one or more values do not meet the one or more criteria.

2. The method of claim 1, wherein the one or more values indicating the severity of the conflict is based, at least in part, on a first severity level associated with the first calendar event, wherein the first severity level is reduced if a priority of the first customer is greater than a priority of the second customer.

3. The method of claim 1, wherein the one or more values indicating the severity of the conflict is based, at least in part, on a second severity level associated with the second calendar event, wherein the second severity level is increased if the priority of the first customer is greater than the priority of the second customer.

4. The method of claim 1, wherein generating the data indicating the exception comprises generating a notification indicating the one or more values indicating the severity of the conflict.

5. The method of claim 1, wherein generating the data indicating the exception to the conflict, comprises:
communicating a first notification indicating a confirmation of the first calendar event if a priority of the first customer is greater than a priority of the second customer; and
communicating a second notification indicating a modification of the second calendar event or a rejection of the second calendar event.

6. The method of claim 1, further comprising:
receiving a request for scheduling data from a computing device associated with second customer;
communicating scheduling data indicating a block of unavailability near or at a start time of the first calendar event to the computing device associated with second customer, if a priority of the first customer is greater than a priority of the second customer; and
communicating scheduling data indicating an availability of a timeslot near or at the start time of the first calendar event to the computing device associated with second customer, if a priority of the second customer is greater than a priority of the first customer.

7. The method of claim 1, further comprises generating calendar data defining one or more calendar events that blocks time around the first calendar event if a priority of the first customer is greater than a priority of the second customer.

8. A system, comprising:
a processor; and
a memory in communication with the processor, the memory having computer-readable instructions stored thereupon that, when executed by the processor, cause the processor to perform a method comprising
receiving scheduling data defining a first calendar event associated with a first customer of a plurality of customers;
receiving scheduling data defining a second calendar event associated with a second customer of the plurality of customers;
generating priority data indicating a priority of individual customers of the plurality of customers, wherein the priority is based, at least in part, on an analysis of contextual data including work history data, wherein the priority of the individual customers is based, at least in part, on a degree of alignment of attributes of the work history data and one or more goals defined in preference data;
generating one or more values indicating a severity of a conflict based, at least in part, on the contextual data, including the priority data;
determining if the one or more values indicating the severity of the conflict meet one or more criteria; and
generating data indicating an exception to the conflict if the one or more values do not meet the one or more criteria.

9. The system of claim 8, wherein the one or more values indicating the severity of the conflict is based, at least in part, on a first severity level associated with the first calendar event, wherein the first severity level is reduced if a priority of the first customer is greater than a priority of the second customer.

10. The system of claim 8, wherein the one or more values indicating the severity of the conflict is based, at least in part, on a second severity level associated with the second calendar event, wherein the second severity level is increased if the priority of the first customer is greater than the priority of the second customer.

11. The system of claim 8, wherein generating the data indicating the exception comprises generating a notification indicating the one or more values indicating the severity of the conflict.

12. The system of claim 8, wherein generating the data indicating the exception to the conflict, comprises:
communicating a first notification indicating a confirmation of the first calendar event if a priority of the first customer is greater than a priority of the second customer; and
communicating a second notification indicating a modification of the second calendar event or a rejection of the second calendar event.

13. The system of claim 8, wherein the method further comprising:
receiving a request for scheduling data, the request received from a computing device associated with second customer;
communicating scheduling data indicating a block of unavailability near or at a start time of the first calendar event to the computing device associated with second customer, if a priority of the first customer is greater than a priority of the second customer; and
communicating scheduling data indicating an availability of a timeslot near or at the start time of the first calendar event to the computing device associated with second customer, if a priority of the second customer is greater than a priority of the first customer.

14. The system of claim 8, wherein the instructions cause the processor to perform the method comprising generating calendar data defining one or more calendar events that blocks time around the first calendar event if a priority of the first customer is greater than a priority of the second customer.

15. One or more computer-readable storage media storing instructions that, when executed by one or more processors of a computing device, perform method comprising:
receiving scheduling data defining a first calendar event associated with a first customer of a plurality of customers;
receiving scheduling data defining a second calendar event associated with a second customer of the plurality of customers;
generating priority data indicating a priority of an individual customer of the plurality of customers, wherein the priority is based, at least in part, on an analysis of contextual data, wherein the priority of the individual customers is based, at least in part, on a degree of alignment between the contextual data and one or more goals defined in preference data;
generating one or more values indicating a severity of a conflict based, at least in part, on the contextual data, including the priority data;
determining if the one or more values indicating the severity of the conflict meet one or more criteria; and
generating data indicating an exception to the conflict if the one or more values do not meet the one or more criteria.

16. The one or more computer-readable storage media of claim 15, wherein the one or more values indicating the severity of the conflict is based, at least in part, on a first severity level associated with the first calendar event, wherein the first severity level is reduced if a priority of the first customer is greater than a priority of the second customer.

17. The one or more computer-readable storage media of claim 15, wherein the one or more values indicating the severity of the conflict is based, at least in part, on a second severity level associated with the second calendar event, wherein the second severity level is increased if the priority of the first customer is greater than the priority of the second customer.

18. The one or more computer-readable storage media of claim 15, wherein generating the data indicating the exception comprises generating a notification indicating the one or more values indicating the severity of the conflict.

19. The one or more computer-readable storage media of claim 15, wherein generating the data indicating the exception to the conflict, comprises:
communicating a first notification indicating a confirmation of the first calendar event if a priority of the first customer is greater than a priority of the second customer; and
communicating a second notification indicating a modification of the second calendar event or a rejection of the second calendar event.

20. The one or more computer-readable storage media of claim 15, wherein the method further comprises:
receiving a request for scheduling data, the request received from a computing device associated with second customer;
communicating scheduling data indicating a block of unavailability near or at a start time of the first calendar event to the computing device associated with second customer, if a priority of the first customer is greater than a priority of the second customer; and
communicating scheduling data indicating an availability of a timeslot near or at the start time of the first calendar event to the computing device associated with second customer, if a priority of the second customer is greater than a priority of the first customer.

21. The one or more computer-readable storage media of claim 15, wherein the contextual data comprises specialty data, and wherein the priority of the individual customer is based, at least in part, on a degree of alignment of attributes of the specialty data and one or more goals defined in the preference data.

22. The one or more computer-readable storage media of claim 15, wherein the contextual data comprises payment data, and wherein the priority of the individual customer is based, at least in part, on a degree of alignment of attributes of the payment data and one or more goals defined in the preference data.

23. The one or more computer-readable storage media of claim 15, wherein the contextual data comprises skill set data, and wherein the priority of the individual customer is based, at least in part, on a degree of alignment of attributes of the skill set data and one or more goals defined in the preference data.

24. The method of claim 21, wherein the contextual data comprises status data, and wherein the priority of the individual customer is based, at least in part, on a degree of alignment of attributes of the status data and one or more goals defined in the preference data.

25. The method of claim 21, wherein the contextual data comprises work history data, and wherein the priority of the individual customer is based, at least in part, on a degree of alignment of attributes of the work history data and one or more goals defined in the preference data.

26. A computer-implemented method comprising:
receiving, at a computing device, scheduling data defining a first calendar event associated with a first customer of a plurality of customers;
receiving, at the computing device, scheduling data defining a second calendar event associated with a second customer of the plurality of customers;
generating priority data indicating a priority of an individual customer of the plurality of customers, wherein the priority is based, at least in part, on an analysis of contextual data, wherein the priority of the individual customers is based, at least in part, on a degree of alignment of attributes of the contextual data and one or more goals defined in preference data;
communicating scheduling data indicating a block of unavailability near or at a start time of the first calendar event to the computing device associated with second customer, if a priority of the first customer is greater than a priority of the second customer; and
communicating scheduling data indicating an availability of a timeslot near or at the start time of the first calendar event to the computing device associated with second customer, if a priority of the second customer is greater than a priority of the first customer.

27. The method of claim 26, wherein the contextual data comprises specialty data, and wherein the priority of the first customer and the priority of the second customer is based, at least in part, on a degree of alignment of attributes of the specialty data and one or more goals defined in the preference data.

28. The method of claim 26, wherein the contextual data comprises payment data, and wherein the priority of the first customer and the priority of the second customer is based, at least in part, on a degree of alignment of attributes of the payment data and one or more goals defined in the preference data.

29. The method of claim 26, wherein the contextual data comprises skill set data, and wherein the priority of the first customer and the priority of the second customer is based, at least in part, on a degree of alignment of attributes of the skill set data and one or more goals defined in the preference data.

30. The method of claim 26, wherein the contextual data comprises status data, and wherein the priority of the first customer and the priority of the second customer is based, at least in part, on a degree of alignment of attributes of the status data and one or more goals defined in the preference data.

31. The method of claim 26, wherein the contextual data comprises work history data, and wherein the priority of the first customer and the priority of the second customer is based, at least in part, on a degree of alignment of attributes of the work history data and one or more goals defined in the preference data.
